(19) United States
(12) Patent Application Publication
(10) Pub. No.: US 2020/0290394 A1
(43) Pub. Date: Sep. 17, 2020

(54) METHOD FOR MAKING WINDOW, EMBEDDED WATERMARK AND OTHER INTEGRATED SECURITY FEATURES IN A THERMOPLASTIC SECURITY DOCUMENT

(71) Applicant: Canadian Bank Note Company, Limited, Ottawa (CA)

(72) Inventors: Marc Gaudreau, Ottawa (CA); Ianthe E.M. Patterson, Ottawa (CA); Thivaharan Thurailingam, Stittsville (CA)

(21) Appl. No.: 16/646,323

(22) PCT Filed: Sep. 11, 2018
(86) PCT No.: PCT/CA2018/051123

§ 371 Date: Mar. 11, 2020

(30) Foreign Application Priority Data
Sep. 11, 2017 (CA) 2978877

(51) Int. Cl. B42D 25/333; B42D 25/351; B42D 25/309; B42D 25/41; B42D 25/435; B42D 25/455; B42D 25/46; B41M 3/14

(52) U.S. Cl. CPC B42D 25/333; B42D 25/351; B42D 25/309; B41M 3/14; B42D 25/435; B42D 25/455; B42D 25/46; B42D 25/41

(57) ABSTRACT

The present invention provides improved methods for making a multiple layer thermoplastic security document having a window using CO₂ laser cutting and engraving in combination with a vision system for precision registration of cut windows of each layer and layer to layer registration and further provides application and registration of security features between layers within the security document body including an embedded gray scale watermark.

### FIELD OF THE INVENTION

The invention relates generally to security documents having substrates comprised of multiple registered layers of thermoplastic with windows formed therein for displaying images, and, more particularly, to such security documents that are resistant to tampering, and methods of making the same.

### BACKGROUND

Security documents such as identification cards, passport's, driver's licences, health cards, etc. typically include one or more printed images which are used to identify the cardholder or other entity associated with the security document. For example, a security document in the form of an identification card, a driver's licence or personal identification sheet of a passport may have a thermoplastic substrate and bear a printed photograph of the person to whom the card, licence or passport was issued (referred to as a personalization image) to identify and verify a person holding the security document. This photograph may, for example, be printed onto a thermoplastic substrate by means of YAG laser marking (also referred to as laser engraving or printing) within a transparent window or other non-transparent area of the document whereby a laser sensitive thermoplastic substrate is marked by applying a YAG laser beam to it which causes it to mark (i.e. discolour) to form the image. A conventional method of laser marking an image on a thermoplastic substrate is raster engraving the image on the substrate laser sensitive thermoplastic on a pixel by pixel (point by point) basis by laser, doing so bidirectionally line by line. Creating windows in security documents is known in the industry and is typically done by die punching or cutting, an example of which is described in the applicant's CBN patent U.S. patent publication no. 20060249951.

The manufacturing of multiple layer security documents is a specialized art that uses many skills and unique processes and materials. In the manufacture of multiple layer thermoplastic cards the greater the complexity of the cards the greater will be the difficulty to counterfeit them and, in turn, such complexity and difficulty to counterfeit provides an inherent value to the product and to the end user or issuing governing body.

Multiple layer thermoplastic cards having either or both of a window and features applied to one or more layers requires that each such layer be registered to the other layers. This layer to layer registration can be achieved in a number of ways some producing tighter tolerances than others. Alignment of multiple layers can be done by pinning or riveting as described in U.S. Pat. No. 4,506,442 for METHOD AND APPARATUS FOR STACKING A PLURALITY OF LAMINATE LAYERS TO FORM A COMPOSITE BOARD, or optically as described in U.S. Pat. No. 8,065,121 for METHOD FOR PIN-LESS REGISTRATION OF A PLURALITY OF LAMINATE ELEMENTS. Layer to layer registration can also include adhering layers together as described in U.S. Pat. No. 7,201,953 for METHOD FOR THE PRODUCTION OF A MULTI-LAYER IDENTITY CARD OF PLASTIC. The term registration used herein is as normally used and understood in the printing industry to refer to precision alignment and placement.

Although it is known to create punched windows in multiple layers and align those layers for lamination it is difficult to achieve a combination of layer to layer registration of a through cut window to printed or other features on a different layer of a security document. U.S. Pat. No. 8,573,650 for SECURITY FEATURE AND METHOD FOR MANUFACTURING THE SAME does so using a combination of a through cut hole and a coating applied around the window region with a laser modifiable marking substance. It describes using the same laser pass to cut the through opening and then modify the laser energy to mark the substance in register with the cut window.

A method of embedding a gray scale watermark within a card structure is described by U.S. Pat. No. 6,752, 432 for IDENTIFICATION CARD WITH EMBEDDED HALFTONE IMAGE SECURITY FEATURE PERCEPTIBLE IN TRANSMITTED LIGHT of which an embedded halftone image security feature becomes visible when the card is viewed in transmitted light but not visible when viewed in reflection. According to this method, an inner information-bearing layer is sandwiched (i.e. interposed) between first and second light-transmissive protective outer layers and contains both visible information-bearing indicia and an imagewise halftone pattern of laser-ablated microholes such that light-transmissivity within the half-tone pattern is imagewise differentiated at each microhole as a function of the microhole's penetration depth.

### SUMMARY OF THE INVENTION

The present invention provides methods for cutting windows in multilayer thermoplastic (e.g. polycarbonate) substrate using CO₂ laser vector processing and registration to lithographic printed matter using vision registration. Further, the present invention provides methods for producing combinations of CO₂ laser window and etch and raster processing and vision registration to lithographic (and/or other manner of forming) printed manner. Unlike conventional die punch processing this method enables production of multiple windows in register and close proximity, with or without raster gray scale features processed and applied during the same CO₂ laser pass, and vision registered to printed matter.

In accordance with the present invention layer to layer registration is provided by CO₂ laser cutting pin hole registration holes in the form of pin holes to the same vision registration marks for each printed thermoplastic layer whereby the registration holes are in tight registration on a layer to layer basis. Advantageously, this produces multiple cuts that are vision registered to the same printed marks by the same laser pass. By contrast, conventional sheet die punching is unable to achieve this.

In accordance with the present invention there is also provided an embedded halftone feature that is registered to one or more layers of a thermoplastic (e.g. polycarbonate) security document. This embedded halftone feature is produced by applying a CO₂ laser beam to melt a thermoplastic inner layer according to predetermined raster (i.e. pixelated) pattern whereby a window of partial transparency is formed. The embedded halftone feature can be embedded as a watermark/window of partial transparency, or in combination with other window or printed layers.

### BRIEF DESCRIPTION OF THE DRAWINGS

The invention is described in detail below with reference to the following drawings drawn to facilitate illustration of features described herein and not to scale.

FIG. 1 is an enlarged partial image of an upper layer of a laminated polycarbonate card shown by FIG. 2 wherein the line beside the “E” is a superimposed line representing a measurement.

FIG. 2 is an enlarged front view image of a laminated polycarbonate card with laser cut window produced using a laser engraver with vision system, comprising two white printed layers in which oval windows were cut wherein the window on the back layer of the card is 10% smaller than the upper layer.

FIG. 3 illustrates an image of Einstein that becomes visible upon application of backlighting to a laminated polycarbonate card having a CO₂ laser raster engraved embedded Einstein image on the backside of a white polycarbonate layer within a multi-layer card construction.

FIG. 4 illustrates on the left-hand-side a CO₂ laser cut and etched (i.e. engraved) vector image on the face of a third layer of a multi-layer card construction, and on the right-hand-side a CO₂ laser cut and etched raster image on a fifth layer of the multi-layer card construction wherein both images (i.e. both the third layer and fifth layer images) are in registration.

FIG. 5 illustrates the back of the multi-layer card of FIG. 4 under application of backlighting. Illustrated is a partial window with partial transparency.

### DETAILED DESCRIPTION

Previously, a thermoplastic security document card having a window has been constructed using a flatbed die punching machine to cut windows in one or more white polycarbonate sheets. Typically, such a card has been constructed of five or more layers of clear and white 500 mm×600 mm polycarbonate sheets having a thickness of 125-375 microns which are then, collated by manually and/or mechanically tapping against the right sheet edges against a rigid stop. In this manner, alignment of the sheets is performed on the basis of the manual/mechanical alignment of the sheet edges. Disadvantageously, however, this introduces a number of accumulative tolerances that result in a low accuracy for sheet to sheet registration, namely, in the order of +/−2.0 mm between each layer. The sheets are then heat tacked together and laminated using heat and pressure. Each sheet contains a total of 48 cards.

The present invention advantageously improves the process for making a multi-layer thermoplastic security document with a window as well as improving the application and registration of security features between sheets within the security document body by using a combination of vision and laser cutting processes.

In contrast, the present invention uses a CO₂ laser processing machine equipped with a vision system to both cut windows in each sheet and perform high precision sheet to sheet alignment on the basis of precision registration of the sheets to printed or marked (i.e. etched or engraved) matter of each sheet. For example, a LasX STS400-2 CO₂ laser engraving machine and integrated cameras comprising the vision system.

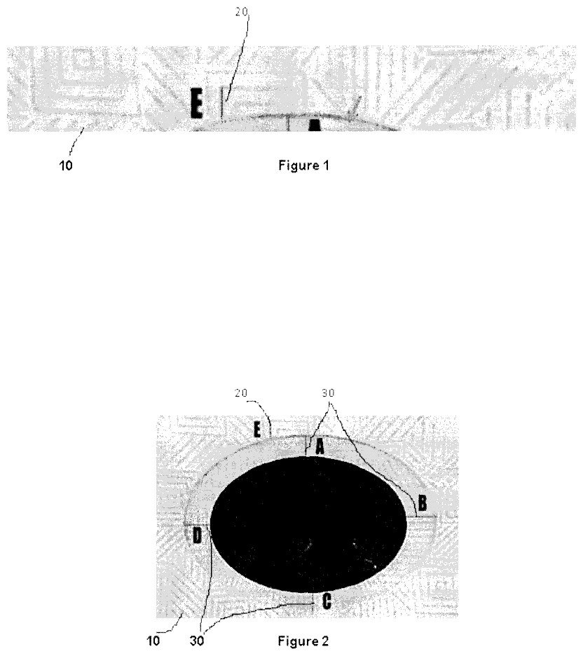

Table 1 illustrates the length from the edge of the window of a card substrate 10 shown in FIG. 2 to location “E” identified by a superimposed line 20 in FIG. 1 and measured on a Keyence VHX 1000 digital microscope. The table represents 10 windows from the same location on 10 different cut sheets. The tolerance of the print to window sheet to sheet was measured to be +/−95 μm.

TABLE 1

| Sample | 1 | 2 | 3 | 4 | 5 | 6 | 7 | 8 | 9 | 10 | Average | STDEV |
|---|---|---|---|---|---|---|---|---|---|---|---|---|
| Measurement (um) | 773 | 974 | 912 | 1028 | 947 | 802 | 907 | 956 | 743 | 834 | 888 | 95 |

To precision align and register the windows of the sheets each layer to be registered has 3 registration pin holes cut in the same laser cutting processing pass. In doing so, each registration pin hole is precisely located in a predetermined location of the sheet by vision registration of the registration pin hole with preselected printed matter on the sheet. The multiple sheet layers may further include one or more optional additional security features in the form of Kinegram, hologram, color shift, ultraviolet, lenses etc. For sheet to sheet registration, a pre-lamination tack table is provided with pins corresponding to the registration pin holes to allow each sheet to be mounted on them with negligible X/Y (axial) movement. Then, in normal manner, the pin-held sheet layers are heat tacked together in register and, using the same registration pin holes, are together pinned to a lamination plate and, thereafter are laminated together to form the composite multi-layer card sheet.

After lamination, cards were examined using the Keyence VHX1000 system and measured at certain locations, namely, distances “A”, “B”, “C” and “D” identified by superimposed lines 30 of FIG. 2, between each face and back cut window. The resulting measurements for a sample of 10 cards is shown in Table 2 (of which measurements are in microns). In the result, a standard deviation of the registration between face and back window is less than 150 μm for the tested 10 card samples.

TABLE 2

| | A | B | C | D |
|---|---|---|---|---|
| 1 | 1235 | 1641 | 826 | 1510 |
| 2 | 742 | 1328 | 881 | 1361 |
| 3 | 980 | 1461 | 1006 | 1567 |
| 4 | 794 | 1326 | 976 | 1509 |
| 5 | 1020 | 1389 | 758 | 1478 |
| 6 | 972 | 1438 | 937 | 1555 |
| 7 | 917 | 1381 | 773 | 1400 |
| 8 | 1039 | 1593 | 1026 | 1530 |
| 9 | 1013 | 1432 | 782 | 1377 |
| 10 | 931 | 1465 | 685 | 1186 |
| Average | 964 | 1445 | 865 | 1447 |
| STDEVA | 136 | 103 | 118 | 118 |

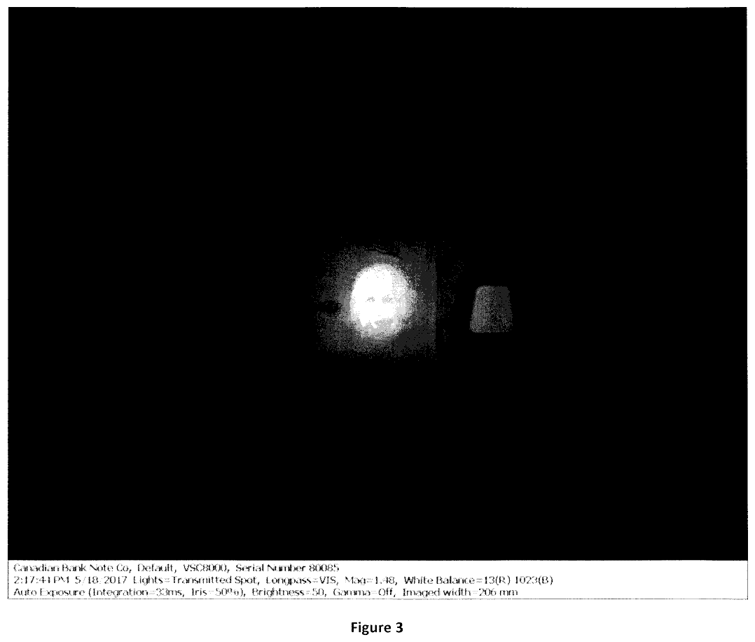

The present invention further provides a method for making an embedded gray scale watermark in the security document and security document formed therefrom. FIG. 3 illustrates an embodiment of such an embedded gray scale watermark comprising an embedded Einstein image that has been laser engraved on the backside of a white layer on the back layer of a multi-layer card construction, wherein an image of Einstein appears upon application of backlighting to the laminated polycarbonate card.

A CO₂ laser printing process engraves (alternately referred to as etches) an image by ablating away (i.e. removing) sheet layer material one pixel at a time and a laser raster process, similar to ink jet printing of an image onto a surface but using ablation rather than depositing ink, scans the image left to right or up and down and pixelates the surface of the material with ablations to create a grey shade image. An embodiment of a raster laser engraved image of Einstein applied to a 125 micron white polycarbonate card sheet is shown in FIG. 3 of which the image is a 300 dpi (dots per inch) bitmap to provide a very high fidelity and high contrast image. The raster engraved sheet is located on the face or back of the laminated sheet and the card sheets are laminated together according to the foregoing window card construction. The laser engraved image (i.e. of Einstein in the illustrated embodiment) forms an embedded gray scale watermark that creates visible gray scale effects when held up to transmitted light.

The embedded gray scale watermark may be integrated with and registered with other security features of print and/or markings applied to the security document by using the registration process described herein to providing an increase of the level of security of the document.

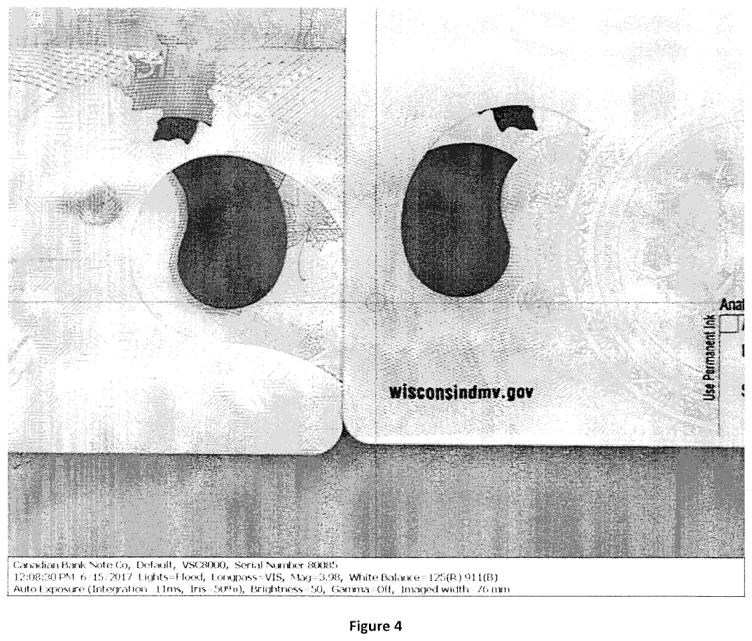

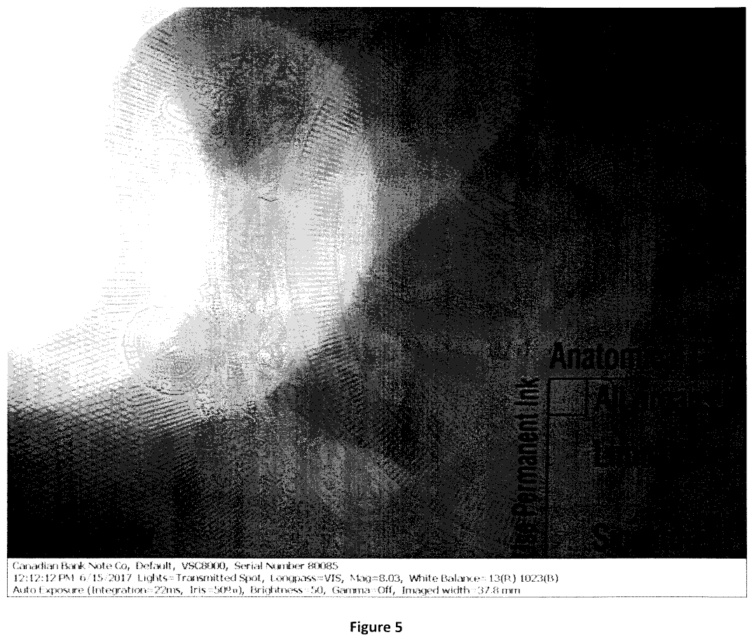

FIGS. 4 and 5 illustrate a further embodiment of the invention comprising complex windows to which vector, etch and raster processing have been applied in accordance with the description herein. FIG. 4 illustrates on the left-hand-side a part of a multi-layer thermoplastic security card having a laser cut and etched vector image on the face of a third layer of the card construction, and on the right-hand-side a laser cut and etched rasterized image on a fifth and back layer of the multi-layer card construction wherein both images (i.e. both the third layer and fifth/back layer images) are in registration. FIG. 5 illustrates the back of the multi-layer card of FIG. 4 under application of backlighting.

The back layer is part of a 100 micron white polycarbonate sheet and the sequence of laser processing used to make this embodiment was to laser cut the window first, followed by the laser raster processing (marking) to form the image. This sequence is required for minimizing any burning of the card layer and maximizing vacuum of the sheet to the belt of the laser printing/engraving equipment.

It is preferable that these laser processed features in combination with a window be processed such that a raster processed feature is applied to the back of the sheet and for the embodiment of FIGS. 4 and 5 to the back of either the third or fifth layer. Registration of these features to printed matter on the face of the sheet is to have an accuracy, that is, a standard deviation of +/−0.35 mm. The backside of the raster processed sheet may include lithographically printed barcode(s) and/or may also include cut marks for vision registration.

The sheet to sheet registration process described herein enables one to create complex combinations of print/marking designs, window shapes and multiple layers of security features layered in register with some being surface features and some being embedded features that are within the card body construction. A combination of a raster feature within a window produces a window of partial transparency.

Forming of the windows during lamination requires polycarbonate window plugging of a size that is at least as large as the footprint of both the face and back cut outs. Edge charring should be taken into consideration when selecting the size and shape of the plug. It is recommended that the plug be about 10% larger than the window footprint and that the edges be smooth curves, not jagged or angular.

What is claimed is:

1. A method of making a multiple layer thermoplastic security document comprising a window using CO₂ laser cutting and engraving in combination with vision system, the method comprising laser cutting windows in layers and registering the window with predetermined printed and/or marked/etched matter on the layering using the vision system, each layer further comprising one or more registration pin holes formed by laser cutting the layer in a predetermined location of the layer by vision registering the registration pin hole with preselected printed matter of the layer using the vision system; aligning the layers on a tack table by mounting each layer to match the registration pin holes of the layer to corresponding registration pins of the tack table to resist axial movement of the layer; heat tacking the layers together in register; pinning the heat tacked layers to a lamination plate using the registration pin holes; and, laminating the layers together.

2. A multiple layer laminated thermoplastic security document formed by the method of claim 1.

3. A method for making an embedded gray scale watermark in a multiple layer laminated thermoplastic security document comprising CO₂ laser engraving by raster processing an image on a backside of a back layer of a multi-layer card construction, wherein the image becomes apparent to viewer of the security document only upon application of backlighting to the laminated polycarbonate card.

4. A multiple layer laminated thermoplastic security document comprising an embedded gray scale watermark and made according to the method of claim 3.

5. A method of making a multiple layer thermoplastic security document comprising complex windows using CO₂ laser vector, etch and raster processing comprising laser cutting and etching a vector image on the face of a middle layer of the multiple layers of the card construction; laser cutting and etching a rasterized image on a back layer of the multiple layer card construction wherein both images are in registration.

6. A multiple layer laminated thermoplastic security document comprising a complex window comprising laser engraved vector and raster images applied according to the method of claim 3.
